(19) United States
(12) Patent Application Publication
(10) Pub. No.: US 2012/0168364 A1
(43) Pub. Date: Jul. 5, 2012

(54) OIL FIELD WATER RECYCLING SYSTEM AND METHOD

(76) Inventor: Thomas S. Evans, Evergreen, CO (US)

(21) Appl. No.: 13/421,639

(22) Filed: Mar. 15, 2012

Related U.S. Application Data
(63) Continuation-in-part of application No. 12/792,164, filed on Jun. 2, 2010.
(60) Provisional application No. 61/454,213, filed on Mar. 18, 2011.
(60) Provisional application No. 61/184,169, filed on Jun. 4, 2009.

(51) Int. Cl. B01D 36/04; C02F 9/08

(52) U.S. Cl. 210/202

(57) ABSTRACT

A system is used for treating contaminated water, that may include some amount of polyacrylamides, emulsified hydrocarbons, and sequestered divalent cations. The system includes at least one pre-treatment tank for initial processing of the contaminated water. Thereafter, the water may be fed to at least one chemical treatment tank fluidically connected to the pre-treatment tank. This treatment tank includes a chemical injection system connected to an interior thereof for introducing a variety break operations, coagulant addition operations, and/or flocculent addition operations. At least one clarifier is fluidically connected to the at least one chemical treatment tank, and includes a mechanical contaminant removal system. A filter skid is fluidically connected to the at least one clarifier, and includes a plurality of filter cartridges.

### CROSS-REFERENCE TO RELATED APPLICATIONS

This application claims priority to and the benefit of U.S. Provisional Patent Application Ser. No. 61/454,213, filed Mar. 18, 2011; and is a continuation-in-part of U.S. patent application Ser. No. 12/792,164, filed Jun. 2, 2010, which claims priority to and the benefit of U.S. Provisional Patent Application Ser. No. 61/184,169, filed Jun. 4, 2009; all of which are entitled, “Oil Field Water Recycling System and Method,” the disclosures of which are hereby incorporated by reference herein in their entireties.

### INTRODUCTION

Water, especially in the western United States and other arid regions, is a valuable resource. Many oil and natural gas production operations generate, in addition to the desired hydrocarbon products, large quantities of waste water, referred to as “produced water”. Produced water is typically contaminated with significant concentrations of chemicals and substances requiring that it be disposed of or treated before it can be reused or discharged to the environment. Produced water includes natural contaminants that come from the subsurface environment, such as hydrocarbons from the oil- or gas-bearing strata and inorganic salts. Produced water may also include man-made contaminants, such as drilling mud, “frac flowback water” that includes spent hydraulic fracturing fluids such as polymers and inorganic cross-linking agents, polymer breaking agents, friction reduction chemicals, and artificial lubricants. These contaminants are injected into the wells as part of the drilling and production processes and recovered as contaminants in the produced water.

Because of the very wide range of contaminant species as well as the different quality of produced water from different sources, efforts to create a cost effective treatment system that can treat or recycle the spectrum of possible produced water streams have been limited.

### SUMMARY

The disclosure describes a novel approach for treating water, such as oilfield production waste. The disclosure describes novel methods for chemically treating contaminated water, such as chemical processes for softening water, demulsifying hydrocarbons, destroying a sequestering effect on divalent cations, destroying any detectable amount or over 99% of aerobic and anaerobic bacteria, and breaking long chain polymers. The disclosure further describes novel methods for clarifying contaminated water to remove suspended solids.

In part, this disclosure describes a method of treating contaminated water, the contaminated water containing some amount of polyacrylamides, emulsified hydrocarbons, and sequestered divalent cations. The method includes performing the following steps:

a) treating a stream of the contaminated water with an effective amount of phosphoric acid and sodium phosphate;

b) treating a stream of the contaminated water with an effective amount of a tight emulsion clarifier for aqueous systems, the tight emulsion clarifier comprises a hydrophobic isobutylene backbone and a hydrophilic maleic hydrophilic component;

c) treating a stream of the contaminated water with an effective amount of calcium carbonate powder and potassium hydroxide; and

d) separating at least some broken solids containing polyacrylamide from a water stream contaminated after the treating operations are performed, by performing one or more of a coagulant addition operation, a flocculant addition operation, a clarifying operation, a filtration operation and a pH adjustment operation to obtain an effluent water stream and a first waste stream of solids separated from the second intermediate water stream.

Another aspect of this disclosure describes a method of treating water. The method includes performing the following steps:

a) treating water with an effective amount of a tight emulsion clarifier for aqueous systems thereby demulsifying at least some emulsified and fluorosurfactant stabilized hydrocarbons contained in the water.

Yet another aspect of this disclosure describes a method of treating water. The method includes performing the following steps:

a) treating water with an effective amount of calcium carbonate and potassium hydroxide thereby reducing water hardness.

An additional aspect of this disclosure describes a method of treating water. The method includes performing the following steps:

a) treating water with an effective amount of phosphoric acid and sodium phosphate thereby reducing water hardness and reducing a chain length of at least some polyacrylamides contained in the water.

In another aspect, the technology relates to a system for treating contaminated water, the contaminated water containing some amount of polyacrylamides, emulsified hydrocarbons, and sequestered divalent cations, the system including: at least one pre-treatment tank; at least one chemical treatment tank fluidically connected to the pre-treatment tank, wherein the treatment tank includes a chemical injection system connected to an interior of the at least one chemical treatment tank; at least one clarifier fluidically connected to the at least one chemical treatment tank, the at least one clarifier including a mechanical contaminant removal system; and a filter skid fluidically connected to the at least one clarifier, wherein the filter skid includes a plurality of filter cartridges.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiment systems and methods described below and are not meant to limit the scope of the invention in any manner, which scope shall be based on the claims appended hereto.

FIGS. 1A and 1B illustrate process flow diagrams of water treatment systems.

FIG. 2 illustrates an embodiment of a method for treating water.

FIG. 3 illustrates an embodiment of a method for treating water.

FIG. 4 illustrates an embodiment of a method for treating water.

FIG. 5 illustrates an embodiment of a method for treating water.

FIG. 6 depicts an embodiment of a chemical treatment tank.

FIG. 7 depicts an embodiment of a clarifier tank.

FIG. 8 depicts an embodiment of a solid waste removal system.

FIG. 9 depicts an embodiment of a filter skid.

FIG. 10 depicts an embodiment of a monitoring station.

### DETAILED DESCRIPTION

This disclosure describes embodiments of novel systems and methods for treating water including, specifically, treating oilfield production waste water to such an extent that it can be either reused or discharged. This disclosure describes chemical processes and a system which breaks long chain polymers common in flowback fluids generated by hydraulic fracturing treatments (hereinafter referred to simply as “frac flowback fluids”). This disclosure further describes chemical processes and systems for softening water, demulsifying emulsified hydrocarbons contained in water, and eliminating a sequestering effect on divalent cations contained in water. These chemical processes and systems do not require digestion or dissolved air flotation.

As discussed above, water, especially in the western United States and other arid regions, is a valuable resource. Many oil and natural gas production operations generate, in addition to the desired hydrocarbon products, large quantities of waste water, referred to as “produced water”. Produced water is typically contaminated with significant concentrations of chemicals and substances requiring that it be disposed of or treated before it can be reused or discharged to the environment. Produced water includes natural contaminants that come from the subsurface environment, such as hydrocarbons from the oil- or gas-bearing strata and inorganic salts. Produced water may also include man-made contaminants generated by the injection of chemicals to improve production from wells. In addition to produced water generated during production, during hydrofracturing operations wells will also generate “frac flowback water” that includes spent hydraulic fracturing fluids such as polymers and inorganic cross-linking agents, polymer breaking agents, friction reduction chemicals, and artificial lubricants. Hydrofracturing, or “frac-ing” is a process whereby the production rates of wells can be increased by the injection of a solution of chemicals that cause the fracturing of the subsurface strata. Frac-ing is a very water intensive process and requires the use of water that is sufficiently clean to allow the frac chemicals to work properly and economically.

Commonly encountered non-natural contaminants in produced water and/or frac flowback water, and their sources, are discussed below.
a. From high-viscosity fracturing operations—gellants in the form of polymers with hydroxyl groups, such as guar gum or modified guar-based polymers; cross-linking agents including borate-based cross-linkers; non-emulsifiers; and sulfate-based gel breakers in the form of oxidizing agents such as ammonium persulfate.
b. From drilling fluid treatments—acids and caustics such as soda ash, calcium carbonate, sodium hydroxide and magnesium hydroxide; bactericides; defoamers; emulsifiers; filtrate reducers; shale control inhibitors; deicers including methanol and thinners and dispersants.
c. From slickwater fracturing operations—viscosity reducing agents such as polymers of acrylamide.

Because of the very wide range of contaminant species as well as the different quality of produced water from different sources, efforts to create a cost effective treatment system that can treat or recycle the spectrum of possible produced water streams have little success.

For example, while reverse osmosis is effective in treating many of the expected natural contaminants in produced water, it is not very effective in removing hydrocarbons and it may be fouled by even trace amounts of acrylamide and other man-made polymers. Further, most attempts to clean oilfield water seem to center on frac water only applications (i.e. recycling on location before/during/after frac jobs) or strictly produced water cleaning for re-injection.

The bias against mixing the streams occurs because while both streams, individually, represent very difficult, but different treatment challenges, in combination they result in an even more difficult challenge. For example, there have been many attempts to reclaim produced water and reuse it as fracturing feed water, commonly referred to as “frac water.” Frac water is a term that refers to water suitable for use in the creation of fracturing (frac) gels which are used in hydraulic fracturing operations. Frac gels are created by combining frac water with a polymer, such as guar gum, and in some applications a cross-linker, typically borate-based, to form a fluid that gels upon hydration of the polymer. Several chemical additives generally will be added to the frac gel to form a treatment fluid specifically designed for the anticipated wellbore, reservoir and operating conditions. However, some waste water streams (particularly frac flowback water) are unsuitable for use as frac water in that they require excessive amounts of polymer or more to generate the high-viscosity frac gel. For example, trace amounts of spent polymer in frac flowback water inhibit the added, fresh polymer from gelling. Because it can be difficult to prevent produced water streams from different sources from being co-mingled, this typically results in all produced water from a well field being made unsuitable for recycling as frac water.

Frac flowback waters frequently contain significant amounts of unbroken gels and polyacrylamides because breaker chemistry is ineffective or improperly applied. Additionally, traditional polymer breaking chemistry used in fracturing operations only works downhole where temperatures are high. These breakers do not work at ambient surface temperatures and pressures. Common breakers are oxidizers such as potassium persulfate, sodium persulfate, and hydrogen peroxide and, of the above, only hydrogen peroxide has any effect at room temperature. The effectiveness of hydrogen peroxide is very limited and dosage rate is very high. Also, standard breaker chemistry in “gel fracs” only reverses the viscosity increase brought on by the crosslinking process. It does not reduce the base viscosity due to the guar polymer concentration and is relatively ineffective in reducing increased viscosity due to “friction reducers” used in “slick water” fracs. Quantities of unbroken/partially broken polymers in frac flowback fluids are a common occurrence at oilfield disposal facilities. This testifies to the relative ineffectiveness of current breaker chemistry.

In general, the water treatment processes and systems in this disclosure can be described as performing a chemical breakdown of undesirable polymers followed by a separation operation. The polymer breakdown operation drastically reduces the polymer chain length of the polymers commonly encountered in oilfield waste water which then allows the water to be reused for other industrial purposes, such as for frac water, for which the untreated produced water is unsuitable. In an embodiment, the industrial uses contemplated are those in which low salt and dissolved solids content is typically not a requirement. However, for industrial uses in which dissolved solids are an issue, the effluent from the treatment system could be diluted with fresh water until the desired chemistry is obtained.

Depending on the embodiment, the polymer breakdown operation may be performed in a single stage or in multiple stages. In the operation, one or more chemicals may be mixed with the produced water to be treated (also referred to as the “raw water”). The mixing may include inline mixing such as through the use of venturi or other mixing valves or flow chambers, mixing in one or more tanks or some combination of the two mixing approaches.

In one embodiment, the raw water is treated with phosphoric acid and sodium phosphate to perform the chemical breakdown of undesirable polymers. The phosphoric acid and sodium phosphate reduce at least some of the chain length of the undesirable polymers contained in the water. Further, phosphoric acid and sodium phosphate reduce water hardness. In another embodiment, the water is treated with a tight emulsion clarifier and/or calcium carbonate powder and potassium hydroxide to assist the phosphoric acid and sodium phosphate in performing the chemical breakdown of undesirable polymers and/or to assist the downstream separation operations. For instance, the tight emulsion clarifier demulsifies at least some of the emulsified hydrocarbons and/or fluorosurfactant stabilized hydrocarbons contained in the water. The calcium carbonate powder and potassium hydroxide destroy a sequestering effect on divalent cations found in the water to facilitate removal of suspended solids in downstream separation operations, such as a coagulation operation and/or a flocculation operation. Further, the calcium carbonate powder and potassium hydroxide reduces water hardness.

The separation operation may be a single stage operation or be performed in multiple stages. In an embodiment of the systems described below, any precipitates or other solids that exist during or result from the polymer breakdown operation may be intentionally carried into the separation operation for removal. Alternatively, easily removable solids that exist during or result from the polymer breakdown operation may be removed as part of the polymer breakdown operation with the following separation operation being used as a final polishing step. In yet another embodiment, sufficient solids removal may be obtained concurrently with the polymer breakdown operation so that no additional and independent separation operation need be performed—in essence the polymer breakdown operation and separation operation being performed simultaneously. In yet another embodiment, in some applications the separation operation need not be performed at all, such as where the industrial application allows for and can handle water with entrained solids. In one embodiment, the separation operation includes a coagulation operation, a flocculation operation, a clarifying operation, and/or a filtering operation.

The water treatment system preferably does not utilize digestion or dissolved air flotation, although depending on the conditions such treatments could be adapted for use with the systems described herein.

Before the water treatment systems are disclosed and described in more detail, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken as quantitatively or source limiting, reference to “a step” may include multiple steps, reference to “producing” or “products” of a reaction should not be taken to be all of the products of a reaction, and reference to “reacting” may include reference to one or more of such reaction steps. As such, the step of reacting can include multiple or repeated reaction of similar materials to produce identified reaction products.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussions regarding ranges and numerical data. Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 4 percent to about 7 percent” should be interpreted to include not only the explicitly recited values of about 4 percent to about 7 percent, but also include individual values and sub-ranges within the indicated range. Thus, included in this numerical range are individual values such as 4.5, 5.25 and 6 and sub-ranges such as from 4-5, from 5-7, and from 5.5-6.5; etc. This same principle applies to ranges reciting only one numerical value. Furthermore, such an interpretation should apply regardless of the breadth of the range or the characteristics being described.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The following is a more detailed description of embodiments of treating water, such as frac flowback water, produced water, and other water contaminated with polymers. In these descriptions, the term ‘effective amount’ will be used to indicate the addition of some amount of chemical necessary to observe a desired treatment effect. The term is used because it is recognized that different operators may have different treatment goals and that the actual amounts used will be determined by those goals, the site conditions and the quality of the water being treated at any given time. Such variables make more precise identification of amounts difficult and premature. Figures illustrating several embodiments of a multistage, continuous treatment system and process are discussed below.

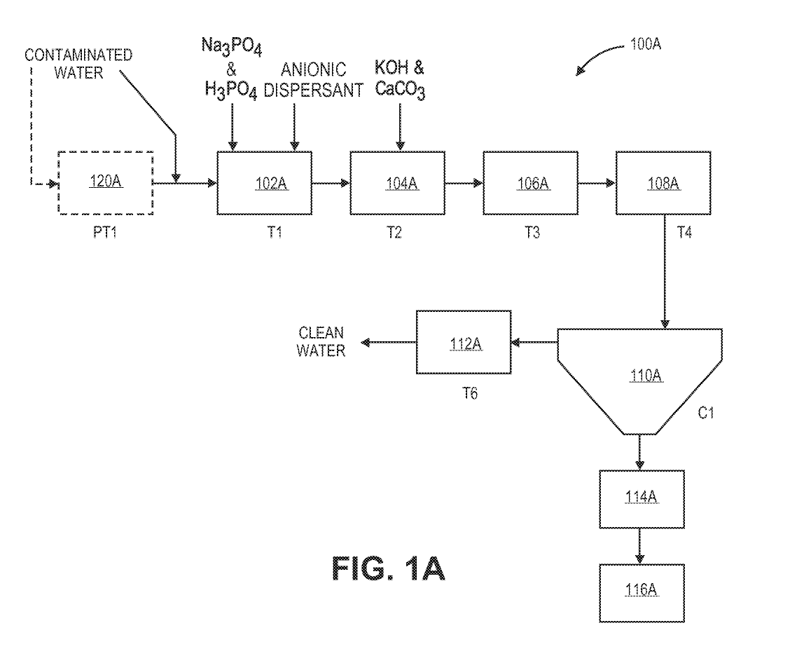

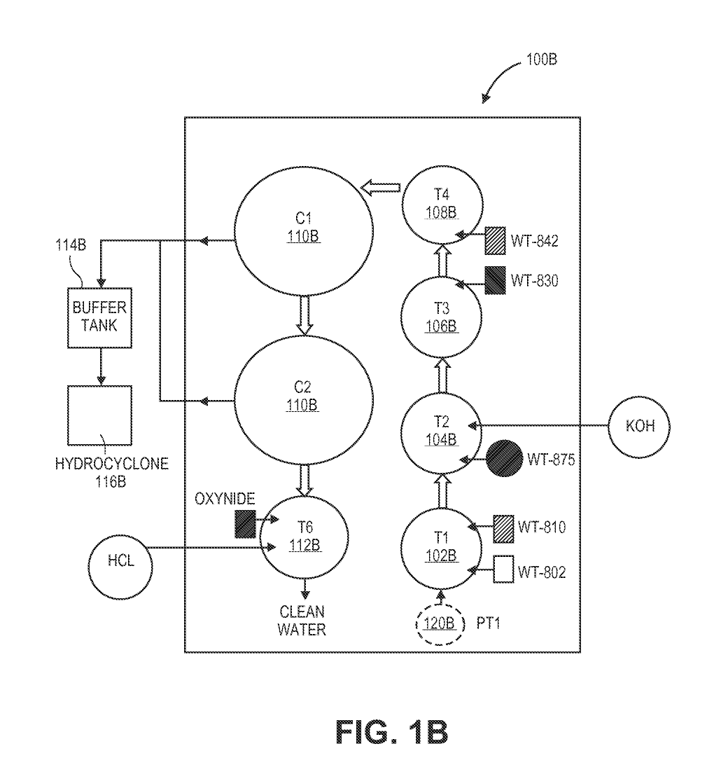

FIG. 1A illustrates a process flow diagram of water treatment system 100A. In FIG. 1A, the water treatment system 100A includes at least one polymer breaking operation and at least one separation operation. A break operation is utilized to chemically break down undesirable long chain polymers, such as polyacrylamides, in water. A separation operation is utilized to remove any precipitates or other solids that exist during or result from the break operation and are carried into the separation operation for removal.

In the embodiment illustrated in FIG. 1A, the water treatment system 100A includes a first break operation 102A, a second break operation 104A, a coagulant addition operation 106A, a flocculent addition operation 108A, a clarifying operation 110A, and a filtering operation 112A. These various operations may take place in one or more pretreatment tanks PT, chemical treatment tanks T, clarifiers C, and other vessels as described below.

The first break operation 102A receives contaminated water. The contaminated water is any water containing any undesirable polymers, such as produced water, frac flowback fluids, and blends thereof. The frac flowback fluids are from both “slick water” and “gel” fracs. They may contain polyacrylamide friction reducers, guar type gels, crosslinkers, and a variety of frac additives. The produced waters are generally 2,000-15,000 TDS brines from producing oil and gas wells. However, the produced water can be as high as 290,000 TDS brines from producing oil and gas wells. Raw produced water also may contain significant quantities of iron oxide, iron sulfides, scales, sulfate reducing bacteria, aerobic bacteria, and hydrocarbons.

In the embodiment depicted in FIG. 1A, contaminated water may be directly fed to the first break operation 102A, or may be subjected to an optional pretreatment operation 120A in one or more 500 bbl upright fiberglass storage/pretreatment tanks. In certain embodiments, six pretreatment tanks may be used, as may other numbers of pretreatment tanks. Fluid enters the top of each pretreatment tank PT1 and is directed through a 45×45 degree angle to create a long circular flow pattern to increase retention time while moving through the pretreatment tank PT1. The exit of each pretreatment tank PT1 is through a 12 inch vertical riser that is open on the bottom end approximately four feet off the bottom of the pretreatment tank PT1. In this way, very effective oil/oil-wet solids separation is achieved in each pretreatment tank PT1 and only the cleanest bottom water travels vertically to the next tank. This results in successively cleaner fluids at each pretreatment tank PT1 and dramatic improvements in water treatability. Each pretreatment tank PT1 is equipped with skimmers to remove accumulated oil/oil-wet solids for separate processing and sale. In addition, each pretreatment tank PT1 contains a drain box arrangement for efficient solids removal and periodic cleaning Without this box, solids may build up and normal draining through a discharge valve would only remove solids near the drain valve, resulting in large accumulations angled over the rest of the pretreatment tank PT1. These accumulations could easily plug the 12 inch riser and move unwanted solids to the next pretreatment tank. Emulsion breaker chemistry and heat can also be applied, usually in the first pretreatment tank, to enhance oil/water separation. In alternative embodiments, the emulsion breaker chemistry may be added in any or all of the other pretreatment tanks.

The contaminated water is directed into a first mixing/chemical treatment vessel or tank T1 for the performance of the first break operation 102A. First break operation 102A treats the contaminated water with a chemical mixture to start the polymeric chain breaking process. In an embodiment, the treatment is performed utilizing:

| | |
|---|---|
| Phosphoric Acid | 50-500 ppm; and |
| Sodium Phosphate | 50-150 ppm. |

This chemical treatment reduces the viscosity of the contaminated water and aids in enhancing water clarity. In an embodiment of the system, fluids enter the bottom of the tank T1 and discharge off the opposite top side of tank T1 although other configurations are also suitable. In an embodiment, chemical injection is at the incoming point of flow although it could be injected into the tank T1 at any point or into the water stream prior to the point of entry. In an embodiment, sample points are maintained at the center of the tank T1 and the discharge of the tank T1 is monitored for the chemistry and the other properties of the water in the first tank T1. In one embodiment, the first break operation 102A utilizes a mixer that mixes the fluid in the first tank T1 at a high rate. In another embodiment, the average retention time of the contaminated water in the first tank T1 by first break operation 102A is about 5 to 15 minutes. In an alternative embodiment, the retention time in the first tank T1 by first break operation 102A is determined based on effluent testing so that effluent is not released from the tank T1 until it reaches some target chemistry.

In an embodiment, successful treatment by first break operation 102A is indicated by a significant reduction in viscosity (particularly with heavy polymer laden frac flowback fluids) and a significant enhancement of the flocing process. In an embodiment, a target reduction of viscosity is less than 50% of input viscosity, with reductions to less than 25% and less than 10% preferred. Without this step, coagulation and flocculation may not happen. In the lab, over-treating at this stage does not seem to have a negative effect on the ultimate suitability for the treated water for industrial reuse. Incoming fluid ratios or other properties such as viscosity may be used to indicate potential treating rates. For example, if the ratio of frac flowback to produced water exceeds 50/50 (as determined based on some analysis of the raw water), the response may be to increase the chemical treatment to provide additional polymer breaking.

In addition to the chemicals identified above, alternate additives may be used (together with or instead of those described above) to breakdown polymers such as:
Potassium Phosphate; and
Ammonium Phosphate.

Several pretreatment operations may be performed simultaneously with the chemical breaking treatments described above with the first break operation 102A in the first mixing/chemical treatment tank T1. In one embodiment, the contaminated water may be pretreated to remove liquid hydrocarbons. In another embodiment, the contaminated water is pretreated with quaternary ammonium chloride compounds to reduce anaerobic and aerobic bacteria levels. In yet another embodiment, batches of contaminated water high in polymer concentrations are pretreated to reduce viscosity, such as with an epi amine (as discussed further below). In a further embodiment, if abnormally high quantities of unbroken gels/polyacrylamides are present in the contaminated water, the water is pretreated with oxidizing chemistry.

In an embodiment, liquid hydrocarbons are removed during the first break operation 102A via gravity settling, through the use of emulsion breaker chemistry and heat, and/or any other suitable process or system for removing hydrocarbons from water. Hydrocarbon removal need not be complete. In an embodiment, the resulting fluids may still contain up to approximately 150-500 ppm oil when processed by the polymer breakdown operation without inhibiting the treatment process.

Recently, service companies have significantly changed their “frac” formulations to include stronger surfactant properties. They have also included fluorosurfactant and micro emulsion technology in order to achieve improved flowback performance following fracturing procedures. These changes have produced a new recycle water condition. The flowback fluid now contains free hydrocarbons, highly emulsified hydrocarbons, and very fine fluorosurfactant stabilized hydrocarbon. Much of the free and lightly emulsified hydrocarbon is being addressed with demulsifier chemistry ahead of the water technology combined with dodecylbenzyl sulfonic acid (DDBSA), specialty alcohols, amines, and non-ionic surfactants.

For example, Protreat supplies products that combine all of these chemistries in one custom formulation, such as the products EB-506, EB-507, EB-508, EB-510, and EB-511. In one embodiment, the treating rate for these products is about 25 to 100 ppm based on total fluid volume treated. In an embodiment, application of any one of these products or a combination of products is done via chemical injection with static mixer in the standard oil/water separation facilities ahead of the water recycle plant.

The tightly emulsified and fluorosurfactant/micro emulsion stabilized hydrocarbons contained in the contaminated water presents a unique and difficult treatment problem. Since the hydrocarbon particles are very small in size (less than 5 micron diameter) and very stabilized by the surfactant/fluorocarbon chemistry, separation by centrifugation, mechanical filtration, chemical and heat, solvent extraction, and other standard oil/water separation techniques are virtually impossible. Therefore, a new approach for oil/water separation is needed.

The first break operation 102A may treat for the tightly emulsified and fluorosurfactant stabilized hydrocarbons utilizing a unique copolymer or tight emulsion clarifier. In one embodiment, the chemical structure of the tight emulsion clarifier includes a hydrophobic isobutylene backbone and a hydrophilic maleic component. In one embodiment, the tight emulsion clarifier may be an anionic dispersant for aqueous systems. The isobutylene backbone has abundant oil attracting sites and the pentane shaped maleic hydrophilic component of the copolymer or tight emulsion clarifier attracts dispersed water wet constituents in the fluid. Further, the tight emulsion clarifier, at the same time, imparts a strong negative charge on the resultant accumulations which sets up a very favorable scenario for subsequence coagulation and flocculation.

In one embodiment, the treating rate of the tight emulsion clarifier is about 20 to 250 ppm. Treatment with the tight emulsion clarifier improves clarity (NTU) of the final product by about 50 to 75%. As used herein the phrase “final product” refers to the effluent or water produced by system 100A or any performed method described herein. In one embodiment, the tight emulsion clarifier is the polycarboxylic acid salt copolymer Rhodoline® 111 as sold by Rhodia Corp. In another embodiment, the tight emulsion clarifier is the copolymer Rohm and Haas Tamol 731A as sold by Dow.

These copolymers were designed for and are typically utilized for stabilizing iron oxide pigments in latex paints. The hydrophobic oxides are attracted to the hydrophobic isobutylene backbone and are then carried to the hydrophilic water base by the hydrophilic maleic “head” of the copolymer in latex paints. This results in a stabilized/dispersed suspension of iron oxide in a water based latex paint that resists settling during storage (i.e. the pigments do not readily settle out to allow for mixing and re-mixing of the paint).

In water treatment system 100A the isobutylene backbone of the copolymer attracts tightly emulsified oil, demulsifies it, (only the hydrocarbons will stick to the backbone, the water will be released), and then uses the maleic component to carry the captured oil into a water based floc for removal. After testing hundreds of copolymers, the tight emulsion clarifier was found to be effective in the water treatment system 100A. As discussed above, two particularly effective tight emulsion clarifiers are Rhodoline® 111 as sold by Rhodia Corp. and Tamol 731A as sold by Dow. Both of these compounds are carboxyl-functional polymers having a hydrophobic component and a hydrophilic component and it is presumed that any polymer structure with these components would be effective.

Alternatively, the water may be treated with silicates to demulsify the emulsified and fluorosurfactant stabilized hydrocarbons instead of utilizing the tight emulsion clarifier. Silicates are very hydrophilic and in this application are effective at drawing water out of emulsion and dispersion allowing the residual hydrocarbons to get caught up in the flocculation process. Without being bound to any particular theory, it is believed that the silicate chemistry works synergistically with phosphoric acid when phosphoric acid is also added to treat the contaminated water in the first break operation 102A. It is further believed that the acid activates the silicate as typified when municipal water treating facilities activate sodium silicate with sulfuric acid prior to application for water clarification. If the silicate is applied with phosphoric acid in the first break operation 102A, then the resulting clarity of the final product is improved by about 25 to 50% compared to a final product produced from applying silicate upstream. In one embodiment, the silicate utilized is sodium silicate Type N (3.22 weight ratio) as sold by PQ Corporation. In another embodiment, the silicate utilized is Kasil 1 Potassium Silicate (2.50 weight ratio) as sold by the PQ Corporation. In yet another embodiment, the silicate utilized in the first break operation 102A is Kasil 6 Potassium Silicate (2.10 weigh ratio) as sold by the PQ Corporation.

In an embodiment, when abnormally high quantities of unbroken gels/polyacrylamides are present in the contaminated water, the water is pretreated with oxidizing chemistry, such as hydrogen peroxide/ammonium persulfate and sodium bisulfite. In one embodiment the pretreatment is performed utilizing:

| | |
|---|---|
| Hydrogen Peroxide/Ammonium | 100-500 ppm; and |
| Persulfate (50/50 Ratio) | |
| Sodium Bisulfite | 50-250 ppm. |

Peroxide and persulfates are strong oxidizers which break down hydrogen bonds and thus destroy long chain polymers. Sodium bisulfite acts as a strong activator for the system and allows it to work at low temperatures (less that 80 degrees Fahrenheit). Oxidizers used for gel/pac breaking traditionally only are effective at high temperatures (over 150 degrees Fahrenheit). This chemistry works quickly ( 5 to 15 minutes) and efficiently. These chemicals would be added individually to the first tank T1 by first break operation 102A ahead of the water recycle stream. In an alternative embodiment, this pretreatment is performed utilizing:

| | |
|---|---|
| Ammonium Persulfate | 100-500 ppm; and |
| Sodium Bisulfite | 50-250 ppm. |

In yet another embodiment, this pretreatment is performed utilizing:

| | |
|---|---|
| Sodium Percarbonate | 100-500 ppm; and |
| Sodium Bisulfite | 50-250 ppm. |

In one embodiment, the effluent from the first tank T1 has a pH that is about 0.5 to 1.0 less than the contaminated water that enters the first tank T1. For example, in one embodiment, the contaminated water that enters the first tank has a pH of about 6.70 and the effluent from the first tank has a pH of about 5.70 to6.20 depending on incoming water quality and make-up. In an embodiment, the effluent from the first tank T1 will have a viscosity that is lower than the contaminated water that enters the first tank T1. In another embodiment, the contaminated water entering the first tank T1 will be dark or opaque with a NTU of about 500-2500. In this embodiment, the effluent from the first tank T1 has no visual color change.

The first tank T1 has a power vent system to remove any hydrogen sulfide (H₂S) gas experienced in the head space of the tank. H₂S is a poisonous gas and presents a serious health hazard if it is not properly removed. H₂S gas is common in disposal waters during the warmer months of the year. Once fluids are treated in a second chemical treatment tank T2 (depicted in FIG. 1A), any remaining H₂S gas is converted chemically to HS, and remains in that form until the pH is lowered in the filtration operation 112A. The recycle process removes most of the HS and thus minimizes any eventual H₂S presence. H₂S scavenging chemistry is added in first tank T1 to further minimize any potential H₂S related problems. Examples of scavenging chemistry that may be used include oxidation processes using hydrogen peroxide, di- or tri-valent iron chemistry, and iron sulfate chemistry, but other chemistries may also be used.

Effluent from the first tank T1 generated by first break operation 102A is transferred to and treated in the second tank T2 by the second break operation 104A. In an embodiment, the second break operation 104A treats the effluent with calcium hydroxide and potassium hydroxide to raise the pH to 10-12.5. It is understood that this step breaks down the remaining polymers and crosslinkers and starts the pin floc process and may be referred to as a pH adjustment operation. In an embodiment, calcium hydroxide is fed at a 5% solution but any suitable concentration may be used in order to achieve the treatment target. The calcium carbonate formed in situ at this stage provides a nucleation site for solids agglomeration. In an embodiment, KOH is fed at a 45% strength. In an embodiment, mixing is at a high rate and average retention time is 5-15 minutes or as necessary to meet the treatment targets.

In one embodiment, the second break operation 104A treats at a specific rate with Ca(OH)₂ and then uses KOH to increase the pH to 12.0 to start. In the lab, an effective lime treating rate of 0.1% by weight (that is treating a weight of water with 0.1% of that weight in lime) has been observed. Going above 0.2% did not help the polymer breaking or the end result. With produced waters, the process has been observed to work down to a pH of 10.5. Polymer-laden waters have been observed to require the 12.0 pH and higher level. Again, over treating at this stage has not appeared to cause problems in the later stages with the exception of the increased cost to neutralize the effluent treated during the filtration operation 112A.

In addition to the chemicals identified above, alternate additives may be used (together with or instead of those described above) in the second tank to achieve the same results such as:
Calcium Oxide;
Magnesium Hydroxide;
Sodium Hydroxide; and
Ammonium Hydroxide.

In an alternative embodiment, due to a series of recent changes in frac fluid make-up, the second break operation 104A treats the effluent produced from the first break operation 102A in the second tank T2 with potassium hydroxide (KOH) and powdered calcium carbonate.

The recent changes in frac fluid make-up include the addition of various chemicals that create sequestration of divalent cations in the water. Some of this sequestration/chelation occurs as a result of using acetic acid in the early stages of the frac to facilitate gel formation. It is frequently added with some sodium acetate. When injected downhole, acetic acid can form sodium acetate, calcium acetate, and/or potassium acetate. Also, copper ion in EDTA is frequently utilized as a catalyst in an attempt to improve gel breaking and acts as a chelation agent for cations. All of these additives set up a condition that seriously negates the lime softening effect of the treating process described below. The formation of calcium carbonate in situ by the addition of calcium hydroxide at high pH is all but eliminated. Coagulation and flocculation of the suspended solids (TSS) in the fluid depend on the availability of calcium carbonate as a nucleation site. Coagulation and flocculation will not occur without the formation of calcium carbonate in situ. Also, the sequestration of divalent cations in the contaminate water prevents softening from occurring.

To combat this sequestering effect, a combination of potassium hydroxide and powdered calcium carbonate is utilized to treat the effluent produced from the first break operation 102A in the second break operation 104A. The shock treatment of potassium hydroxide in combination with natural calcium in the water results in the formation of calcium carbonate in situ. No calcium hydroxide is required. Because the quantity of calcium carbonate formed in situ is highly variable, powdered calcium carbonate is then added to supply ample nucleation sites and facilitate coagulation and flocculation of the suspended solids. Powdered calcium carbonate may be utilized because it provides an extremely high level of surface area available for attraction of particulates. Further, the use of powdered calcium carbonate greatly enhances the “softening” effect of the calcium carbonate formed in situ.

Lime softening typically provides from about 55 to 65% reductions in hardness. This new combination process (of KOH and powdered calcium carbonate) provides for more than 95% reduction in water hardness. In an embodiment, the KOH and powdered calcium carbonate may be added in amounts to achieve a maximum reduction in hardness but, alternatively the system can be operated to achieve any target hardness reduction such as a 50% reduction, a 75% reduction a 90% reduction a 95% reduction or a maximum achievable reduction. The process is synergistic and requires both chemistries in order to work. Neither chemical (KOH or powdered calcium carbonate) appears as effective by itself as in combination, suggesting the two in combination work sympathetically to enhance treatment. In an embodiment, the strength of potassium hydroxide in this process is about 45 %. In an embodiment, treatment rate is about 200 to about 2000 ppm depending on water quality. In an embodiment, extremely high purity calcium carbonate from Missouri deposits is utilized to treat the effluent during the second break operation 104A in the second tank T2. The calcium carbonate from Missouri deposits has very low levels of aluminum, magnesium, silica, and iron, which is sold by Mississippi Lime as CalCarb R2 200 mesh. In an embodiment, the treatment rate of the powdered calcium carbonate is about 100 to 1000 ppm depending on water quality during the second break operation 104A and the desired reduction in water hardness.

Another major observed advantage of treating at a pH of about 12.0 or higher at this stage is that this pH kills all detectable amounts or over 99% of aerobic and anaerobic bacteria in the contaminated water. Water containing detectable amounts of or 1% or more bacteria compared to the contaminated water fed into the water treatment system 100A cannot be re-used. It is critical that the water be free of any detectable amount of bacteria or contains less than 1% bacteria compared to the contaminated water prior to being shipped to the field.

As discussed above, the pH will be raised in the second tank T2. In one embodiment, the pH in the second tank T2 is about 12 to 12.2. Additionally, pin floc may begin to appear within the second tank T2. Further, solid precipitate may begin to appear in the second tank T2.

Effluent generated by second break operation 104A is treated with a coagulant addition operation 106A in a third chemical treatment tank T3 with a coagulant. There are two types of coagulants. In one embodiment, a mixture of both types is used in the coagulant addition operation 106A.

The first type of coagulant is inorganic. Inorganic coagulants include the aluminum-based and iron-based compounds. Iron-based coagulants include ferric sulfate, ferric chloride and ferrous sulfate. Iron chemistry for coagulation has major drawbacks in the oilfield. While iron-based coagulants are effective at coagulating polymer when used in this process, they typically require large dosages and add dissolved iron to the water. The dissolved iron eventually oxidizes somewhere in the system causing severe scale deposition which operators interpret as major corrosion problem. Iron-based coagulants also results in large sludge volumes. For these reasons, aluminum-based coagulants are preferred over iron-based coagulants in this application.

The second type of coagulant is organic, which include polyamines, polydiallyldimethyl ammonium chloride cationic polymers (polyDADMACS), and epi-DMA (see below for a discussion of epi-DMA). While epi-DMA is preferred, polyamines and DADMACS do produce coagulation. Depending on the embodiment various combinations of two or more inorganic coagulants may be used to achieve synergistic effects.

As mentioned above, an embodiment of the process uses a combination of inorganic and organic coagulants to achieve a synergistic effect that is much believed to be an improvement over using either type of coagulant by itself. Another benefit of using the combination of coagulant types is that additional polymer breaking is provided as an insurance policy in the event polymer remains in the water that reaches the third tank.

An example of an embodiment of the coagulant used in coagulant addition operation 106A is the following mixture:

| | |
|---|---|
| Aluminum chlorohydrate | 25-500 ppm |
| Epi-DMA (HMW) | 25-500 ppm |

In which epi-DMA refers to epichlorohydrin/dimethyl amine copolymers (sometimes also referred to as epi-DMA amines or epi-amines) and high molecular weight (HMW) refers to a general characterization of the molecular weight of the epi-DMA. For the purposes of this application, HMW refers to molecular weight in the range of 500,000 to 10,000,000; Medium molecular weight (MMW) refers to 100,000 to 500,000; Low molecular weight (LMW) refers to less than 100,000; Very high molecular weight refers to greater than 10,000,000. Epi-DMA are copolymers that vary in molecular weight and cationic charge density and, thus, possess differing abilities to coagulate different suspended solids in various waters. Examples of suitable epi-DMA include:

| Manufacturer | Brand Name of Product | Molecular Weight Range |
|---|---|---|
| Ciba Geigy | Magnafloc LT-7990 | LMW |
| | Magnafloc LT-7991 | MMW |
| | Magnafloc LT-7981 | MMW |
| | Agefloc B50LV-P | HMW |
| | Agefloc A50LV-P | HMW |
| Kimira/Cytec | SF 587 | MMW |
| | SF 589 | MMW |
| | SF 591 | HMW |
| | SF 2535 CH | HMW |
| | Calloway C-4000 | LMW |
| | Calloway C-4015 | MMW |
| | Calloway C-4030 | MMW |
| | Calloway C-4050 | HMW |
| Polymer Research | PRC 505 | LMW |
| Corp | PRC 507 | MMW |
| | PRC 509 | MMW |
| | PRC 512 | HMW |
| | PRC 518 | HMW |
| SNF Inc | Floquat FL 2250 | LMW |
| | Floquat FL 2449 | LMW |
| | Floquat FL 2550 | MMW |
| | Floquat FL 2749 | MMW |
| | Floquat FL 2949 | MMW |
| | Floquat FL 3050 | HMW |
| | Floquat FL 3249 | HMW |

In addition to those listed above, any equivalent or similar epi-DMA, now known or later developed, may be used although different compounds may require different treatment amounts to achieve the target chemistry for this step.

Aluminum compounds are believed to be the most effective (treating rate and cost) coagulants for the purpose described. With aluminum chlorohydrate (ACH), the metal ion is hydrolyzed and appears to form aluminum hydroxide floc as well as hydrogen ions. It has another benefit in the least effect on alkalinity of any of the aluminum-based coagulants. It is believed that these aluminum floc structures are particularly effective at removing color and colloidal matter. Both are adsorbed onto/into the metal hydroxide. ACH also produces much lower volumes of sludge than traditional coagulants and works over a much wider pH range. It has one of the highest basicity and lowest treating rate of all the coagulants. In testing, adequate treatment is observed when the process treats to a target of 50 ppm ACH in the third tank T3.

It is believed that this step neutralizes the negatively charged suspended particles with a strongly cationic chemical combination and that the epi amine breaks down any residual polymer that has gotten this far in the process and produces a smaller/tighter/stronger floc structure. In testing, a significant pin floc is formed at this point and the mixing speed is high to provide high collision rates. The amount of pin floc found in the third tank T3 is greater than the amount found in the second tank T2. Again, retention time is about 5 to 15 minutes but may be varied to achieve specified results. In an embodiment, fluids enter the bottom of the third T3 tank and discharge off the opposite top side of the third T3 tank. In an embodiment, chemical injection is at the incoming point of flow although it could be injected into the third T3 tank at any point or into the water stream prior to the point of entry. In an embodiment, sample points are maintained at the center and discharge of the third T3 tank for monitoring the chemistry and other properties of the water in the third tank T3.

In an embodiment, treatment in the coagulant addition operation 106A may be dependent upon results of the flocculent addition operation 108A. Poor turbidity and/or poor floc formation may be used to indicate improper treating rates at flocculent addition operation 108A in a fourth chemical treatment tank T4. In an embodiment, the process may include sampling at the discharge of the third tank T3 and quickly performing a bench test to get advanced results. Loose floc may be used to indicate over treating at the coagulant addition operation 106A while high turbidity may be used to indicate under treating at coagulant addition operation 106A. The amount of floc in the fourth tank T4 will be greater than the amount of floc found in the third tank T3. Further, clear water may begin to appear surrounding and/or above the floc in the third tank T3.

In addition to the chemicals identified above, alternate additives may be used (together with or instead of those described above) in the third tank T3 during the coagulant addition operation 106A to achieve the same results such as:
Polyaluminum Chloride
Aluminum Sulfate
Polyaluminum Chloride Sulfate
Polyaluminum Silicate Sulfate
Various molecular weight and charge density polyamines
Various molecular weight and charge density epi-DMA
Various molecular weight and charge density polydiallyldimethyl ammonium chloride cationic polymers (DADMACS)

Effluent from the third tank T3 generated by coagulant addition operation 106A is treated with a flocculant in the fourth tank T4 during the flocculent addition operation 108A. There are three types of flocculants: Cationic including copolymers of acrylamide and DMAEM (dimethyl-aminoethyl-methacrylate), copolymers of acrylamide and DADMAC, and Mannich amines; Anionic including polyacrylates, copolymers of acrylamide and acrylate; and Non-ionic including polyacrylamides. In embodiments of flocculent addition operation 108, the preferred flocculant used are anionic copolymers of acrylamide and acrylate however any of the three types may be used. For example, in one embodiment the flocculant is:

| | |
|---|---|
| HMW Anionic Polyacrylamide | 1-5 ppm |

During testing, in this step large flocculated masses were formed from the suspended solids by using high molecular weight long chain polymers. Mixing rate is slow and utilizes paddle mixers to reduce/eliminate shearing of flocs. In an embodiment, floc structures sink rapidly and do not float. However, even if the floc structures float the treatment is the same. Again, average retention time is about 5 to 15 minutes but may be varied to achieve specific treatment targets. In an embodiment, fluids enter the bottom of the T4 tank and discharge off the opposite top side of the tank T4. In an embodiment, chemical injection is at the incoming point of flow although it could be injected into the fourth T4 tank at any point or into the water stream prior to the point of entry. In an embodiment, sample points are maintained at the center and discharge of the fourth T4 tank for monitoring the chemistry and other properties of the water in the fourth tank T4.

This process encourages oil separation when oily water enters the system 100A. Free oil tends to accumulate in the fourth tank T4. Free oil destabilizes the floc and is detrimental to water clarification. A skim port is also installed in the fourth tank T4 to facilitate removal of free oil.

In addition to the chemicals identified above, alternate additives may be used (together with or instead of those described above) in the fourth tank T4 to achieve the same results such as:
Various molecular weight and charge density anionics
Various molecular weight and charge density cationics
Non-ionic polyacrylamide

Multiple sample points are unique at the fourth tank T4 in that they are designed to sample floc structures without damaging the floc as with normal small diameter tubing (about ¼″ to about ½″). They consist of large diameter tubing (from about 1″ to about 3″) with adjustable bottom valves for accurate sampling.

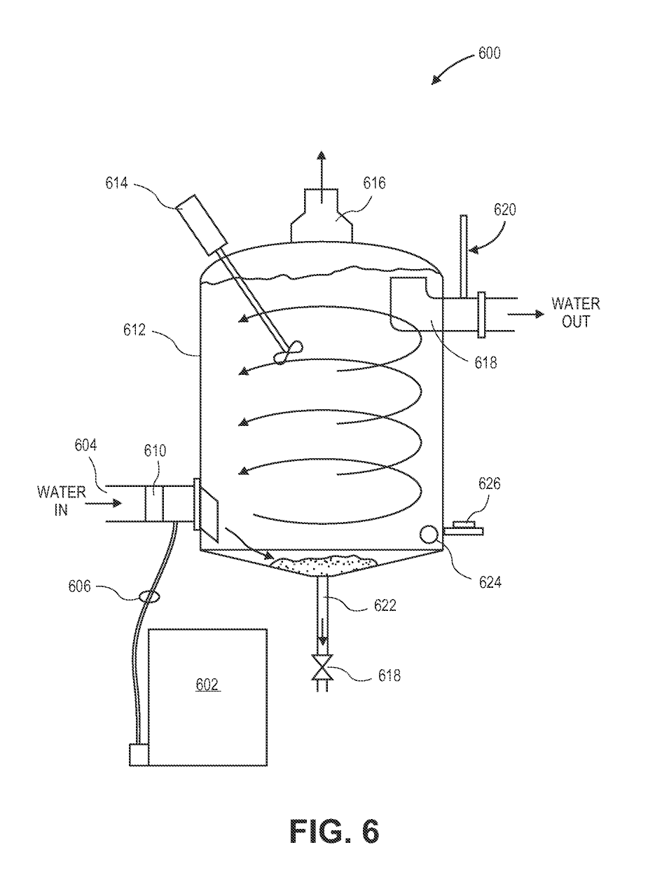

A particular embodiment of the chemical treatment tanks T1-T4 is depicted in FIG. 6. The structure of tanks T1-T4 may be identical or may differ from each other as required for applications, treatment processes, etc. Each chemical treatment tank 600 may be used alone or in conjunction with other tanks. Additionally, the chemical treatment tank 600 may be used in one or more break operations 102A, 104A, in a coagulant addition operation 106A, or a flocculent addition operation 108A. In the depicted embodiment, a chemical tote container 602 may be connected to a fluid inlet 604 via a chemical introduction line 606. This chemical introduction line 606 may introduce fluids before or after a flow meter 610. Alternatively, it may introduce chemicals directly into an interior of the vessel housing 612.

The flow meter 610 may be mechanical, pressure-based, optical, open channel, thermal mass, vortex, electromagnetic, or any other type of flow meter that may measure the flow of the incoming fluid. The chemical tote container 602 may contain chemicals that aid in the filtration of the water. In embodiments, these chemicals may help with the flocculation, demulsifying, or coagulation of containments of the frac water. In embodiments, incoming water enters the tank 600 through a pipe or some other means of fluid transport at the fluid inlet 604. A mixer 614 may be used to agitate the fluid by creating a circular flow pattern.

The tank 600 may have a vent system 616. In embodiments, this vent system 616 may be a power vent system to remove any gas, such as hydrogen sulfide (H₂S) gas, experienced in the interior head space of the tank. H₂S is a poisonous gas and presents a serious health hazard if it is not properly removed. One acceptable ventilation system is a Dayton Grainger PowerVent Fan, 6″ size, ¾ hp, approx. 500 cfm. Due to the caustic nature of H₂S gas, explosion proof stainless steel exhaust fans are generally desirable.

In embodiments, the fluid exits through a riser 618. At the top of riser 618, a vent 620 is utilized to prevent air bubbles from forming and restricting flow. The vent 620 may operate automatically and continuously to provide up to 50% additional throughput. Solid waste exits through an outlet 622 in the bottom of the tank 600. Heat can also be applied in to enhance oil/water separation. A jet valve 624 may be included for improving cleaning ability of the interior of the tank 600. One or more sample valves 626 may also be installed in the tank body for periodic or regular testing of the liquid therein. A discharge valve 628 may control the flow of solid waste via the outlet 622. In certain embodiments, sample points are maintained at the center and discharge of the tank for monitoring the chemistry and other properties of the water in the tank. Continuous pH monitoring may be performed via Hach instrumentation. For each new application, laboratory bench testing should be performed to determine what constituents are in the water and what treating regime will best work in that situation. Effluent from last of the chemical treatment tanks is fed into a clarifier tank C1 for a clarifying operation 110A.

The clarification operation 110A is for floc settling, separation and removal, although it should be noted that any separation system or process could be used instead of clarifiers as long as the solids are adequately removed. In the embodiment of the system depicted in FIG. 1A, effluent from the fourth tank T4 generated by flocculent addition operation 108A is fed into a clarifier tank C1 for a clarifying operation 110A. The clarifying operation 110A includes floc settling, separation and removal. Accordingly, within the clarifier tank C1, the floc may settle to the bottom of the clarifier with a large layer of clear water being formed above the floc. However, it should be noted that any separation system or process could be used instead of a clarifying operation 110A as long as the solids are adequately removed. In an embodiment, the average retention time in the clarifier tank C1 is about 10 to 60 minutes. In an embodiment, clear fluids may be gravity fed off the top to the next stage, if any. Accumulated solids are removed from the tank bottom and fed to auxiliary storage for dewatering and any water obtained may be added to the clarifier tank effluent or at any earlier stage of the process. In an embodiment, fluids enter the clarifier tank C1 at a point approximately 30% above the tank bottom and exit in the opposite top side of tank. Sample points may be maintained at one or more of the bottom, center, and discharge of the clarifier tank C1. In an embodiment, continuous monitoring of turbidity (NTU) is performed with Hach instrumentation.

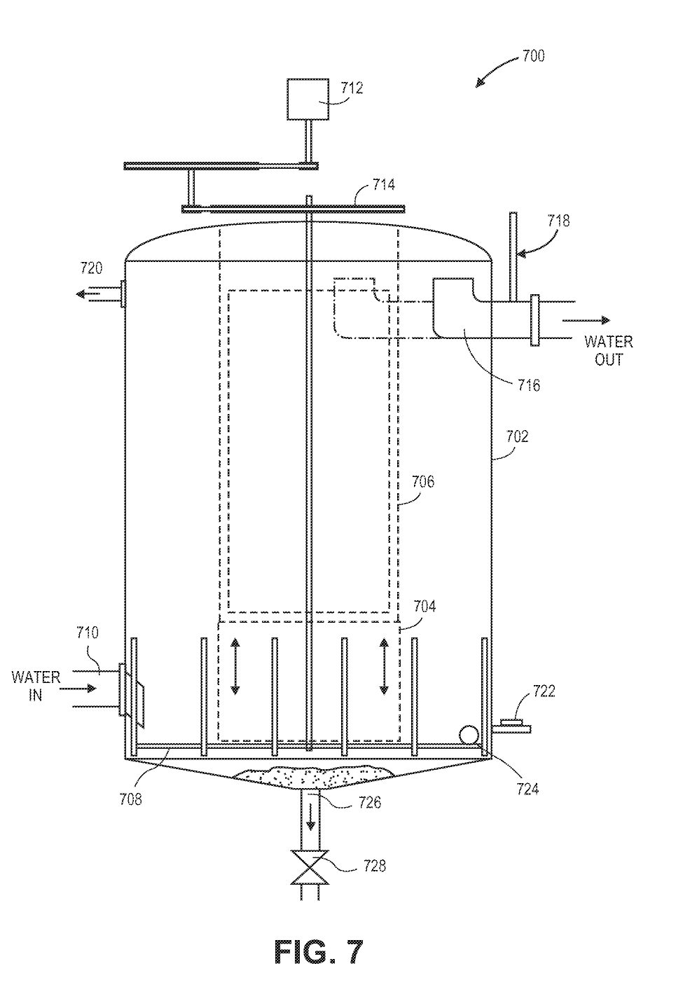

One such clarifier tank 700 is depicted in FIG. 7. The tank 700 includes a housing 702 including one or more internal movable curtains 704 and one or more internal stationary curtains 706 utilized to contain flocs, encourage rapid settling, and minimize floc carryover to the next stage. These curtains 704, 706 may be circular and divide the tank volume into approximately 36% inside the curtain/64% outside the curtain; other curtain dimensions may be utilized.

In an embodiment, the internal movable curtain 704 is mounted on the bottom of stationary curtain 706 to allow for height adjustments above a rake 708. The curtains 704, 706 may be manufactured of plastics or metals, such as HDPE, stainless steel, or other materials. In this way, varying floc structures can be more effectively settled by adjusting the thickness of the solids bed in relation to the rake height. Height adjustments of the movable curtain 704 are made from the top of the clarifier 700 with chains or cables. Fluid enters the bottom of the clarifier housing 702 at an inlet 710 and may be directed at a downward 45×45 degree angle to encourage settling in the annular area of the clarifier. Solids then move by gravity down the cone bottom of the clarifier tank 700.

A rake mechanism is constructed using the rake 708, a motor 712, and rake drive mechanism 714. The rake drive mechanism 714 may include, in one embodiment, a 17,500:1 gear reduction mechanism controlled by a variable frequency drive (VFD) so that precise rotational speeds can be used to process varying floc qualities. The rotational speed of the rake 708 may be between about one-half revolution/10 minutes and about 2 revolutions/10 minutes. In the embodiment utilizing the 17,500:1 gear reduction mechanism, about one revolution/10 minutes is obtained. The rake 708 has six arms with paddles that produce a concentric sweep of the bed solids to the discharge fitting in the bottom of the tank 700. A rake 708 having greater than or fewer than six arms may also be used.

Clean fluid exits the clarifier housing 702 out the top on the opposite side of the infeed through a vertical riser 716. It can be discharged from either the inside or outside of the stationary curtain 704 through a valve system that allows the cleanest water to be moved to the next step depending on the operational characteristics of the floc involved. The valve system is readily adjustable. A vent 718 similar to vent 620 is located proximate the riser 716. In embodiments, skim line 720 is used to remove occasional floating solids from either the inside or the outside of the curtains 704, 706. Removed solids are floated off and sent to a slop tank located in the main tank battery outside the plant. Sample valve 722 allows for sampling of processed fluids at various locations both inside and outside of the curtain in the clarifier. In embodiments, one or more jet valves 724 are located on the lower circumference to allow jetting of solids toward the central discharge point during cleaning operations. These valves may greatly improve cleaning efficiency and reduce cleaning times.

In embodiments, solids are discharged from a discharge line 726. Discharged bottom solids from the clarifier system 700 are controlled by a discharge valve 728. This discharge valve 728 may be controlled as to rate and volume by an electric valve control and timing device. Times and volumes can be adjusted and programmed to meet specific floc/solids and flow characteristics. The timing device may be programmed to open the discharge valve 728 for several seconds every few minutes. Depending on the particular application, the discharge valve 728 may be opened about every 2, 5, or 10 minutes, for about 1 to about 60 seconds.

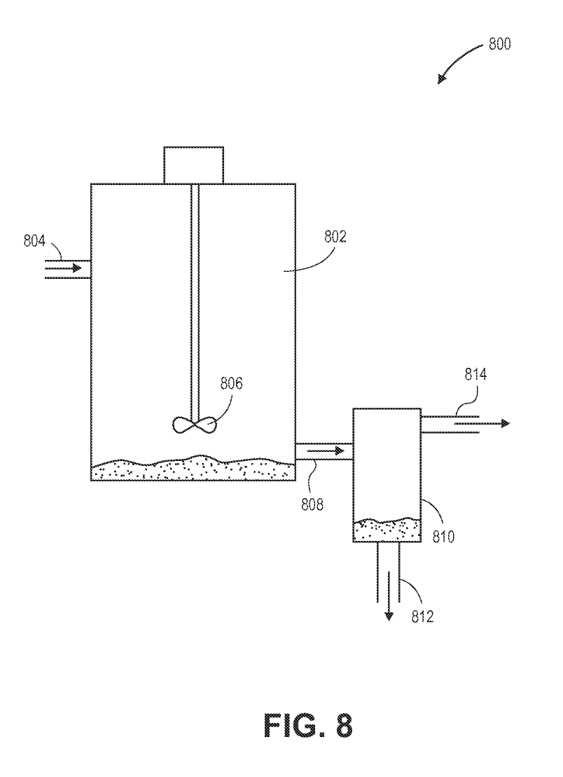

As depicted in FIG. 1A, discharged solids from the clarifier C1 are delivered to a 750 gallon buffer tank 114A and hydrocylone 116A for additional solid waste removal. An exemplary embodiment of this solid waste removal system 800 is depicted in FIG. 8. In the system 800, a buffer tank 802 receives fluid from the clarifier tank C1 via an inlet 804. The fluid may be agitated with a mixer 806. In embodiments, a pump is used to move fluid through a drain 808 to a hydrocyclone 810. In other embodiments, the movement of fluid may be gravity-driven. In embodiments, the hydrocyclone 810 separates the clarifier discharge into approximately 10% heavy sludge removed from outlet 812 and 90% light solids fluid removed from outlet 814. The 90% portion may be transported back to the first tank T1 for dilution of incoming contaminated water and further processing. Clear water is drained off from the bottom of the filter box for recycle through the plant. Solids filtered out are either dried or concentrated via filter press or drum drying. Additionally, fan press dewatering systems, such as those manufactured by Prime Solutions, Inc., also may be utilized. Final solids are sent to landfill or otherwise disposed of.

In the embodiments illustrated, discharge from the clarifier tank C1 is fed through a 50 micron filter of the filtration operation 112A at a tank T6 and it is treated with HCl to neutralize the pH (to about 7.0-8.0). The filter of the filtration operation 112A will pick up any residual floc particles. A moderate mixing speed in tank T6 may be used to assist the neutralization treatment. In an embodiment, fluids enter the tank T6 at the bottom and exit on the opposite top side of the tank. Chemical injection may be at the point of fluid entry or any other location. In an embodiment, continuous pH monitoring is performed via Hach instrumentation and sample points are maintained at the center and discharge of the tank T6. Turbidity is monitored at the discharge of the tank via Hach instrumentation. A biocide (e.g., DBNPA, THPS, Thione, and/or WSKT 10) can be added at this point if bacteria testing indicates high aerobic or anaerobic bacteria levels exist.

The effluent passes through a filter skid where it flows through two cartridge filters before entering the clean water storage tanks These filters of the filtration operation 112A are variable in size. In one embodiment, the filters are a 25 micron filter followed by a one micron filter. Any combination of filters and filter sizes may be utilized in the filtration operation 112A.

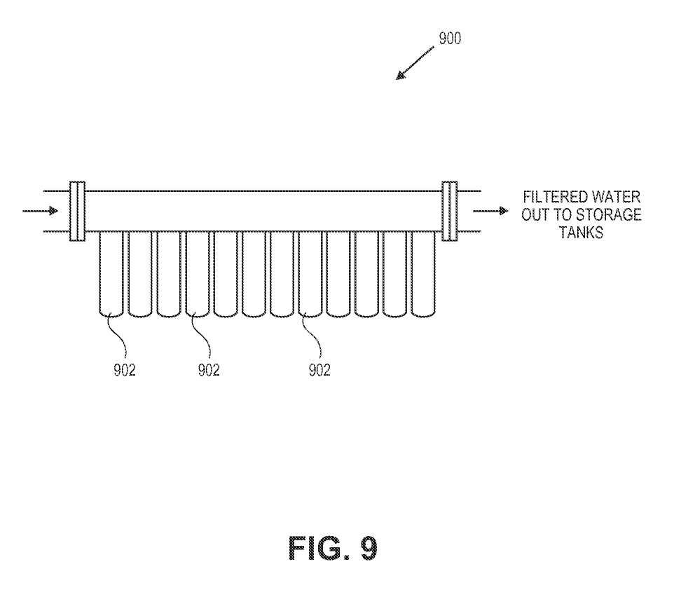

For example, a figure skid 900 is depicted in FIG. 9. This filter skid 900 may be configured to allow fluid to flow through any number of cartridge filters 902 individually or in any combination. In certain embodiments, up to 16 or more cartridge filters may be utilized. In an embodiment, the filters 902 are located in filter canisters constructed of clear polycarbonate so that continuous visual observation of water quality can be made. The filters 902 may accept 5, 10, 20, 30, and 50 micron cartridges and are plumbed so that any desired combination can be utilized. Each cartridge may be equipped with pressure gauges so that constant pressure drops can be monitored to ensure proper cartridge changes are made in a timely manner. Cartridges may be designed so that they can be cleaned and reused to save on filter costs.

Cleaned water is sampled for quality control and pumped to six 500 bbl upright fiberglass storage tanks in the main tank farm where it is held for trucking to well locations. Plant monitoring of fluids includes ORP/pH/temp for all incoming fluids. ORP/pH/Temp are monitored at first tank T1. Temp and pH are monitored at second tank T2. Turbidity/pH/Temp are monitored at tank T6. In an alternative embodiment, ORP/pH/Temp may be monitored at a first tank T1, and temp and pH may be monitored at a second tank T2 Incoming flow rate is monitored at the 10 inch feed line. All measurements are fed to and displayed on a Hach computer at the test bench where all quality control testing is done. Laser levels measurement of outside chemical storage tanks is displayed on monitors at the process test bench.

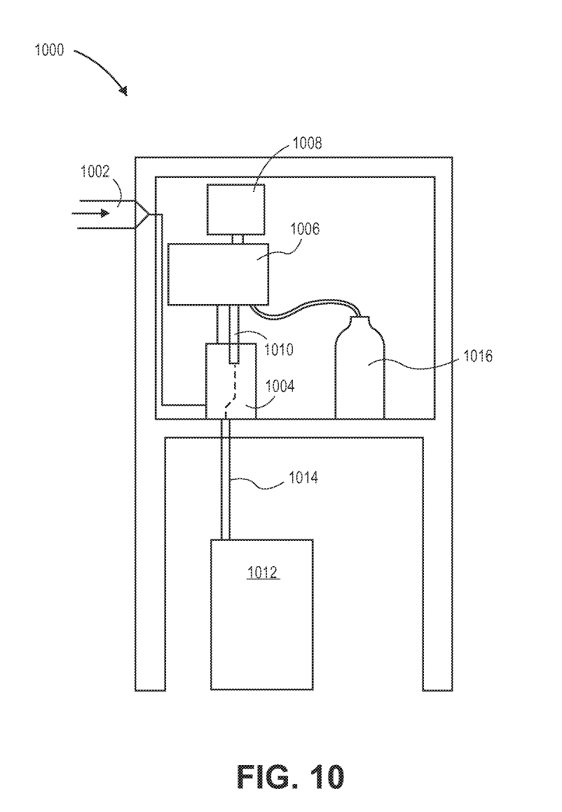

Continuous monitoring of total sulfide levels is done with equipment designed for this process, such as that depicted in FIG. 10. In embodiments, continuous monitoring of total sulfide levels may be performed with a sulfide monitoring system 1000. One such monitoring station is the Model A15/81 Dissolved Sulfide Monitor, manufactured by Analytical Technology. Accurate control of sulfide levels is critical due to the toxic nature of H₂S gas in the plant and the eventual conversion of sulfides to elemental sulfur which causes hazing in cleaned water. The monitoring equipment converts total sulfides (H₂S/HS/S) to H₂S and then measures total sulfides. Use of this equipment is desirable to measure the effectiveness of sulfide removal chemistry in the recycle process and to ensure an acceptable quality water is being produced. Fluid from the clarifier C1 enters through inlet 1002 and into holding cup 1004. An analyzer 1006 draws samples from the holding cup 1004. The results are displayed on display 1008. The analyzer discharge pipe 1010 discharges the spent sample to a storage vessel 1012. Excess fluid may be discharged at a drain 1014. Analyzing chemicals such as sulfuric acid are maybe connected to the analyzer 1006 and stored in an analyzing chemical container 1016.

In one embodiment, the tank T6 only receives clear water with a pH of about 7 to 8. In another embodiment, the water within the tank T6 has a turbidity of about 0.5 to 1.0 NTU. In another embodiment, the water contained in the tank T6 will have a reduced hardness of about 50 to 95% compared to the contaminated water entering the first tank T1. In yet another embodiment, the water contained in the tank T6 will be free of any detectable amount of bacteria or contain less than 1% bacteria compared to the contaminated water fed into the water treatment system 100A.

In addition to the chemicals identified above, alternate additives may be used (together with or instead of those described above) in the fourth tank during the flocculent addition operation 108A to achieve the same results such as:
Sulfuric Acid;
Acetic Acid;
Any suitable acid; and
Other non-cationic biocides.

The final product or effluent from process 100A produces clear neutralized water suitable for reuse in fracs, drilling fluids, workover fluids, kill fluids, plug drilling fluids, and well cleanout fluids. Turbidity quality control goals are less than 5.0 NTU although any treatment level may be targeted and the system adjusted to obtain the targeted treatment level. Due to the inherent TDS levels (4000-15000 mg/l), this water may not be suitable for surface drilling or other uses without further treatment. Continuous monitoring for quality control is done via Hach instrumentation and includes pH at incoming, second tank and the sixth tank. Turbidity is monitored at incoming water and the sixth tank. ORP is monitored at incoming water. All data is fed to a central computer where continuous visual readout and date logging is available. The instrumentation also controls all chemical pumps via a 4 to 20 ma output signal on incoming data.

In an embodiment, all mixers are 375 revolutions per minute (RPM) gear down type although any suitable type may be used. In an embodiment, the first and second tanks may be operated at about 125 to 150 RPM; the third tank may be operated at about 250 to 275 RPM; the fourth tank may be operated at about 50 to 75 RPM with paddle blades; the fifth tank will not be mixed; and sixth and seventh tank are operated at about 125 to 150 RPM.

In an embodiment, the system 100A will routinely sample at the exit of each tank to verify effectiveness which is compared to a minimum effective treating rate for all fluids at each point in the process.

In some instances above, the exact concentration and form of the chemicals being added is not specifically defined. In such instances, it should be noted that any suitable form selected based on availability, economics and ease of use may be used without changing the ultimate ability of the system to treat the produced water. Different selections may require adjustments in treatment times, sizes of feed tanks or other equipment or use of alternative equipment (for example when a dry form is substituted for an aqueous form). However, the system and process may be modified, as is known in the art, to utilize such alternative forms and achieve the desired level of treatment without undue experimentation.

The system 100A as described above may optionally be followed with other treatment stages. For example, in an embodiment water from filtration operation 112A is fed through nanofiltration equipment to reduce the TDS to less than 1000 mg/l. This would produce higher quality water suitable for applications where low TDS water is required (drilling operations where spent mud is land applied) and where low chlorides are necessary to reduce corrosion potentials. Alternatively or in addition to the nanofiltration, water may be run through a reverse osmosis system to produce dischargeable quality water.

Embodiments of the system 100A may be designed to any desired throughput as continuous or batch systems. In an embodiment, a system 100A, as illustrated in the FIG. 1A, is sized to handle flow rates of about 50 to about 600 gpm. The footprint will be approximately 80 feet by 60 feet. The footprint may be sized to include a 500 bbl frac tank for clean water storage and a filter tank for clarifier bottoms, or these may be located outside of the footprint. In this embodiment, the tanks are 2500 gal and the clarifier is 6900 gal. Further, in this embodiment, all chemical tanks are 275 gal totes. If a Ca(OH)₂ tank is utilized, it is 500 gal. In an embodiment, the system 100A could be mounted on a 40 foot drop deck trailer with small process tanks (for example, around 500 gal) and auxiliary storage, but with a decrease in throughput.

An alternative embodiment of a water treatment system 100B is depicted in FIG. 1B. The systems depicted in FIGS. 1A and 1B share certain similar components, tanks, etc., and include like designators for such similar components, where appropriate. Differences between the two systems are also described below. The alphanumeric indicators (e.g., “WT-875”) depicted in FIG. 1B denote the various chemical formulations introduced to each tank. The various types of chemicals that may be used at various stages of the process also are described below.

This system 100B includes a second clarifier C2 for a second clarifying operation 110B′. The second clarifier C2 is generally identical to the first clarifier C1 except that it need not contain a rake mechanism due to the significantly lower volume of solids it is required to remove. A rake mechanism may be utilized, if desired or required, however. Like the first clarifier C1, a solid waste outlet of the second clarifier C2 may be connected to the buffer tank 114B.

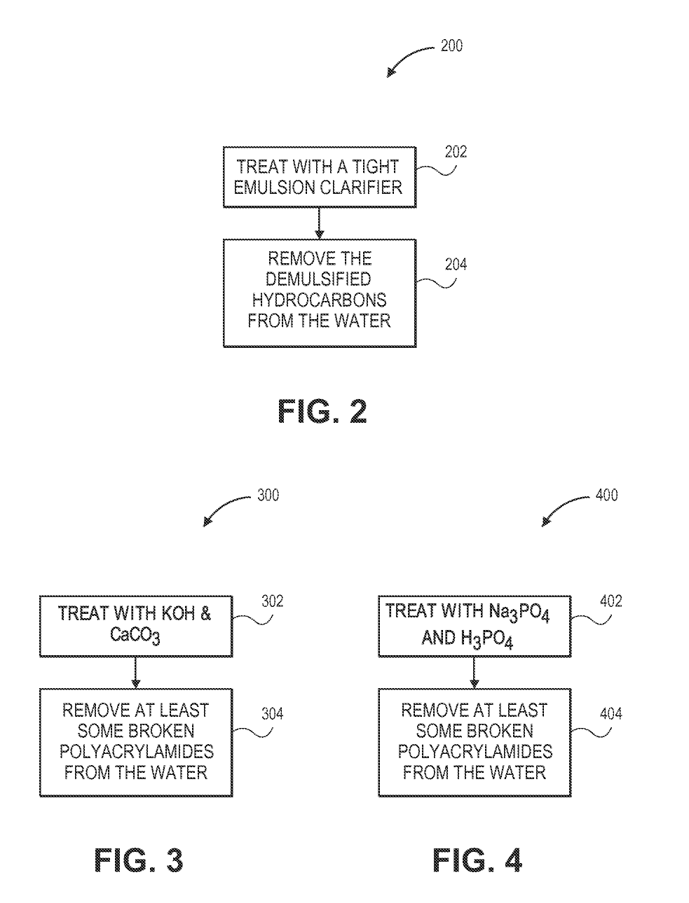

FIG. 2 illustrates an embodiment of method for treating water 200. As illustrated in FIG. 2, method 200 utilizes a treatment operation 202. Treatment operation 202 treats water with an effective amount of a tight emulsion clarifier for aqueous systems. In one embodiment, the tight emulsion clarifier includes a hydrophobic isobutylene backbone and a hydrophilic maleic hydrophilic component. The tight emulsion clarifier demulsifies at least some emulsified and fluorosurfactant/micro emulsion stabilized hydrocarbons contained in the water. This allows the hydrocarbon to be removed from the water.

In another embodiment, method 200 further performs a removal operation 204. The removal operation 204 removes any demulsified hydrocarbons from the water after treating with the tight emulsion clarifier.

In one embodiment, the tight emulsion clarifier is at least one of Rhodoline® 111 and Rohm and Haas Tamol 731A. In another embodiment, the tight emulsion clarifier increases clarity of the final product by about 50 to 75%. In another embodiment, the water is treated at a rate of about 50 to 250 ppm with the tight emulsion clarifier.

FIG. 3 illustrates an embodiment of method for treating water 300. As illustrated in FIG. 3, method 300 utilizes a treatment operation 302. Treatment operation 302 treats water with an effective amount of calcium carbonate powder and potassium hydroxide. The treatment reduces the hardness of the water. In one embodiment, treatment operation 302 reduces water hardness by more than 95%. In another embodiment, treatment operation 302 provides for 100% water softening.

The treatment operation 302 further destroys a sequestering effect on divalent cations contained in the water to facilitate the removal of at least some suspended solids from the water in downstream separation steps, such as during flocculation and coagulation. In another embodiment, method 300 further performs a removal operation 304. The removal operation 304 removes at least some reduced chain length polyacrylamides from the water after treating with the calcium carbonate powder and potassium hydroxide. Further, in yet another embodiment, the strength of the potassium hydroxide is about 45%.

FIG. 4 illustrates an embodiment of method for treating water 400. As illustrated in FIG. 4, method 400 utilizes a treatment operation 402. Treatment operation 402 treats water with an effective amount phosphoric acid and sodium phosphate. The treatment operation 402 reduces water hardness.

The treatment operation 402 further reduces the chain length of at least some polyacrylamides contained in the water, which allows for the removal of these compounds. In another embodiment, method 400 further performs a removal operation 404. The removal operation 404 removes at least some of the reduced chain length polyacrylamides from the water after treating with the phosphoric acid and sodium phosphate.

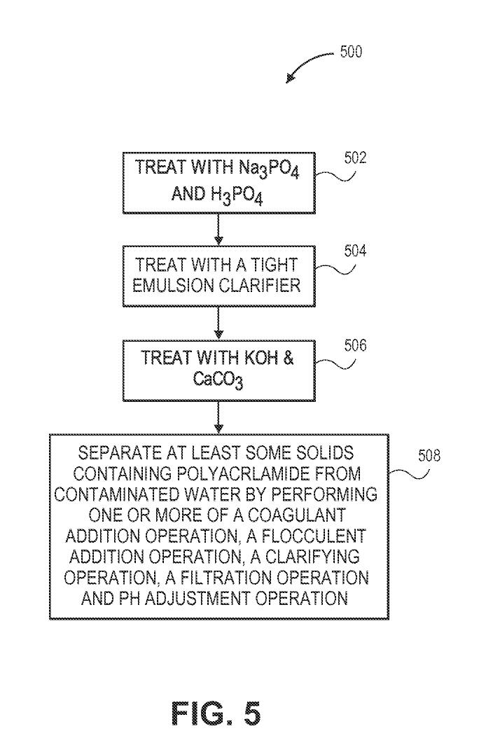

FIG. 5 illustrates an embodiment of method for treating contaminated water 500, the contaminated water containing some amount of polyacrylamides, emulsified hydrocarbons, and sequestered divalent cations. As illustrated, method 500 performs three different and independent treatment operations on contaminated water, such as the treatment operation described above in methods 200, 300, and 400. The treatment operations may be performed in any order or sequence. Method 500 treats contaminated water with sodium phosphate and phosphoric acid 502. The sodium phosphate treatment operation 502 reduces the chain length of at least some of the polyacrylamides contained in the water. Further, the sodium phosphate treatment operation 502 reduced water hardness.

Method 500 further treats the contaminated water with calcium carbonate powder and potassium hydroxide 504. The calcium carbonate powder treatment operation 504 reduces hardness of the contaminated water. In one embodiment, calcium carbonate powder treatment operation 504 reduces water hardness by more than 95%. In another embodiment, calcium carbonate powder treatment operation 504 provides for 100% water softening. The calcium carbonate powder treatment operation 504 destroys a sequestering effect on divalent cations contained in the water to facilitate the removal of at least some suspended solids from the water in downstream separation steps, such as during flocculation and coagulation. Further, in yet another embodiment, the strength of the potassium hydroxide is about 45%.

Method 500 additionally treats the contaminated water with an effective amount of a tight emulsion clarifier for aqueous systems. In one embodiment, the tight emulsion clarifier includes a hydrophobic isobutylene backbone and a hydrophilic maleic hydrophilic component. The tight emulsion clarifier demulsifies at least some emulsified and fluorosurfactant stabilized hydrocarbons contained in the water, which allows these hydrocarbons to be removed from the water.

Next, after the above treatment operations 502, 504, and 506, method 500 perform a separation operation 508. The separation operation 508 separates at least some broken solids containing polyacrylamide from a water stream contaminated after the treating operation are performed by performing one or more of a coagulant addition operation, a flocculent addition operation, a clarifying operation, a filtration operation, and a pH adjustment operation to obtain an effluent water stream and a first waste stream of solids separated from the second intermediate water stream. The coagulant addition operation, flocculent addition operation, clarifying operation, filtration operation, and pH adjustment operations may be any suitable separating operations for a water treatment system. In one embodiment, the coagulant addition operation, flocculent addition operation, clarifying operation, filtration operation, and pH adjustment operation are identical the above operations described in FIG. 1. In another embodiment, the separation operation 508 further removes the demulsified hydrocarbons from the contaminated water after treating with the tight emulsion clarifier.

One benefit of the systems and processes described herein is that they do not require the use of excessive amounts of sodium hydroxide to break down polymers and they do not use expensive mechanical processes to treat the water.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope of the present invention. For example, one or more of the tanks could be replaced with plug flow or other reactor types. Numerous other changes may be made which will readily suggest themselves to those skilled in the art and which are encompassed in the spirit of the disclosure.

### EXAMPLES

In one example, contaminated water was ran through a system 100A according to FIG. 1A. The system 100A was ran utilizing the following compounds at the listed amounts in the appropriate tanks as described above:

| Tightly emulsified clarifier | 100 ppm |
|---|---|
| Phosphoric acid and sodium phosphate | 200 ppm |
| Potassium Hydroxide (45%) | 0.25% |
| Calcium hydroxide (5% solution) | 0.25% |
| Coagulant | 60 ppm |
| Flocculant (0.20% solution) | 0.25% |
| Hydrochloric acid | 0.20% |

Measurements were taken of the contaminated water fed into system 100A. Measurements were taken of the water after treatment with system 100A. Table 1 below lists the measurements from the contaminated water and from the water after treatment with system 100A.

TABLE 1

| | Contaminated | After |
|---|---|---|
| General Parameters | Water | Treatment |
| pH | 6.4 | 7.5 |
| Electrical Conductivity | 26400 | 28400 |
| Total Dissolved Solids (180) | 19700 | 19800 |
| Solids, Total Dissolved (Calc) | 16200 | 20300 |
| Total Suspended Solids | 108 | 28 |
| Turbidity | | |
| Sulfate Reducing Bacteria | >100,000 | 1-10 |
| Alkalinity, Total (As CaC03) | 847 | 857 |
| Hardness, Calcium/Magnesium | 687 | 205 |
| (As CaC03) | | |
| Nitrogen, Ammonia (As N) | 28.6 | 27 |
| Oxygen Demand - BOD | ND | ND |
| Oxygen Demand - COD | 3790 | 4020 |
| Oxygen, Dissolved | | 11 |
| Oil & Grease, N-Hexane Extractable | 1500 | 11 |
| Radium | 39.5 | 2.79 |
| Total Radium 228 | 18.5 | ND |
| Redox - | −406 | −3471 |
| Sulfide | ND | ND |
| Sulfide as H2S | ND | ND |
| Sodium Adsorption Ratio | 106 | 191 |
| Anions | 268.6 | 335.9 |
| Alkalinity, Bicarbonate as HC03 | 1030 | 1050 |
| Alkalinity, Carbonate as C03 | ND | ND |
| Alkalinity, Hydroxide as OH | ND | ND |
| Chloride | 8920 | 11300 |
| Fluoride | 1.3 | 1 |
| Nitrogen, Nitrate-Nitrite (as N) | ND | |
| Sulfate | ND | ND |
| Cations | 294.5 | 330.6 |
| Calcium | 236 | 82.1 |
| Magnesium | 23.9 | ND |
| Potassium | 97.8 | 2060 |
| Sodium | 6400 | 6300 |
| Cation/Anion Balance | 110% | 98% |
| Dissolved Metals | | |
| Aluminum | ND | ND |
| Antimony | 0.02 | 0.011 |
| Arsenic | ND | ND |
| Barium | 19.6 | 1.02 |
| Beryllium | ND | ND |
| Bismuth | ND | ND |
| Boron | 49.5 | 45.3 |
| Cadmium | 0.003 | ND |
| Calcium | 236 | 82.1 |
| Chromium | ND | 0.01 |
| Cobalt | ND | 0.031 |
| Copper | 0.008 | ND |
| Iron | 169 | 0.18 |
| Lead | ND | ND |
| Lithium | 11.3 | 10.9 |
| Magnesium | 23.9 | ND |
| Manganese | 3.32 | ND |
| Molybdenum | ND | 0.04 |
| Nickel | ND | ND |
| Phosphorus | 1.4 | 0.6 |
| Potassium | 97.8 | 2060 |
| Selenium | ND | 0.077 |
| Silicon | 72.7 | 25.6 |
| Silver | ND | 0.02 |
| Sodium | 6400 | 6300 |
| Strontium | 45.8 | 16.4 |
| Sulfur | 6.7 | 224 |
| Thallium | ND | ND |
| Titanium | ND | ND |
| Uranium | ND | ND |
| Vanadium | 0.01 | ND |
| Zinc | ND | 0.08 |
| Total Metals | | |
| Aluminum | 0.6 | 0.2 |
| Antimony | 0.492 | 0.223 |
| Arsenic | ND | 0.21 |
| Barium | 22.1 | 1.08 |
| Beryllium | 0.14 | 0.28 |
| Bismuth | 1.16 | 0.13 |
| Boron | 54.7 | 49.5 |
| Cadmium | 0.011 | ND |
| Calcium | 259 | 84 |
| Chromium | 0.12 | 0.01 |
| Cobalt | 0.021 | 0.087 |
| Copper | 0.01 | ND |
| Iron | 206 | 0.3 |
| Lead | 0.15 | 0.07 |
| Lithium | 14 | 13.9 |
| Magnesium | 30.6 | 0.4 |
| Manganese | 3.91 | ND |
| Molybdenum | ND | 0.083 |
| Nickel | ND | ND |
| Phosphorus | 2 | 1.1 |
| Potassium | 100 | 2110 |
| Selenium | ND | 0.371 |
| Silicon | 77 2 | 26.2 |
| Silver | 0.09 | 0.23 |
| Sodium | 6740 | 6320 |
| Strontium | 54.8 | 17.9 |
| Thallium | 0.19 | 0.04 |
| Titanium | ND | ND |
| Uranium | 0.7 | 1.5 |
| Vanadium | 0.016 | 0.029 |
| Zinc | ND | 0.09 |
| 8260B Volatile Compounds-Water | | |
| 1,1,1,2-Tetrachloroethane | ND | ND |
| 1,1,1-Trichloroethane | ND | ND |
| 1,1,2,2-Tetrachloroethane | ND | ND |
| 1,1,2-Trichloroethane | ND | ND |
| 1,1-0ichloroethane | ND | ND |
| 1,1-0ichloroethene | ND | ND |
| 1,2,3-Trichloropropane | ND | |
| 1,2-0ibromo-3-chloropropane | ND | ND |
| 1,2-0ibromoethane | ND | ND |
| 1,2-0ichlorobenzene | ND | ND |
| 1,2-0ichloroethane | ND | ND |
| 1,2-0ichloropropane | ND | ND |
| 1,4-0ichlorobenzene | ND | ND |
| 2-ButaNDne 1000 1100 | 1000 | 1100 |
| 2-HexaNDne | ND | ND |
| 4-Methyl-2-pentanone | 3500 | 2600 |
| Acetone | 2900 | 5700 |
| Acrylonitrile | ND | 1100 |
| Benzene | 3000 | ND |
| Bromochloromethane | ND | ND |
| Bromodichloromethane | ND | ND |
| Bromoform | ND | ND |
| Bromomethane | ND | ND |
| Carbon disulfide | ND | ND |
| Carbon tetrachloride | ND | ND |
| Chlorobenzene | ND | ND |
| Chloroethane | ND | ND |
| Chloroform | ND | ND |
| Chloromethane | ND | ND |
| cis-1,2-0ichloroethene | ND | ND |
| cis-1,3-0ichloropropene | ND | ND |
| Dibromochloromethane | ND | ND |
| Dibromomethane | ND | ND |
| Ethylbenzene | 35 | ND |
| lodomethane | ND | |
| m,p-Xylenes | 650 | ND |
| Methylene chloride | ND | ND |
| o-Xylene | 180 | ND |
| Styrene | ND | ND |
| Tetrachloroethene | ND | ND |
| Toluene | 2500 | 690 |
| trans-1,2-Dichloroethene | ND | ND |
| trans-1,3-Dichloropropene | ND | ND |
| trans-1,4-Dichloro-2-butene | ND | ND |
| Trichloroethene | ND | ND |
| Trichloroftuoromethane | ND | ND |
| Vinyl acetate | ND | ND |
| Vinyl chloride | ND | ND |
| Surr: 1,2-Dichloroethane-d4 | 105 | 108 |
| Surr: 4-Bromoftuorobenzene | 99.3 | 103 |
| Surr: Dibromoftuoromethane | 109 | 110 |
| Surr: Toluene-d8 | 101 | 104 |
| 8260B MBTEXN-Water | | |
| MTBE | ND | |
| Benzene | 2500 | 740 |
| Toluene | 2300 | 450 |
| Ethylbenzene | 58 | ND |
| m,p-Xylenes | 820 | 59 |
| o-Xylene | 220 | 22 |
| Xylenes, Total | 1000 | 81 |
| Naphthalene | 460 | |
| GRO by 8260 (nC6-nC1 0) | 13000 | 4500 |
| Surr: 4-Bromofluorobenzene | 99.4 | 110 |
| 8015C Diesel Range Organics-Water | | |
| Diesel Range Organics (nC10-nC32) | 4800 | 38 |
| Surr: o-Terphenyl | 0 | 0 |
| Methane | | ND |

In a second example, contaminated water was ran through a system 100 according to FIG. 1. The system 100 was ran utilizing the following compounds at the listed amounts in the appropriate tanks as described above:

| Tightly emulsified clarifier | 100 ppm |
|---|---|
| Phosphoric acid and sodium phosphate | 200 ppm |
| Potassium Hydroxide (45%) | 0.25% |
| Calcium hydroxide (5% solution) | 0.25% |
| Coagulant | 60 ppm |
| Flocculant (0.20% solution) | 0.25% |
| Hydrochloric acid | 0.20% |

Measurements were taken of the contaminated water fed into system 100A. Measurements were taken of the water after treatment with system 100A. Table 2 below lists the measurements from the contaminated water and from the water after treatment with system 100.

TABLE 2

| | Contaminated | | After | |
|---|---|---|---|---|
| General Parameters | Water | | Treatment | |
| 2-Methylnaphthalene | 120 | ug/l | 16.5 | ug/l |
| Naphthalene | 43 | ug/l | 37.5 | ug/l |
| Benzoic Acid | 430 | ug/l | 278 | ug/l |
| 2,4-Dimethylphenol | 180 | ug/l | 128 | ug/l |
| 2-Methylphenol | 900 | ug/l | 731 | ug/l |
| 4-Methylphenol | 570 | ug/l | 400 | ug/l |
| Acetone | 8800 | ug/l | 5860 | ug/l |
| Benzene | 2400 | ug/l | 1200 | ug/l |
| 1,2-Dichloroethane | 71 | ug/l | NO | ug/l |
| Ethylbenzene 1 | 50 | ug/l | 130 | ug/l |
| 1,1,2-Trichloroethane | 130 | ug/l | NO | ug/l |
| Toluene | 4100 | ug/l | 1700 | ug/l |
| Xylene | 2800 | ug/l | 2250 | ug/l |
| Aluminum | 0.133 | mg/l | <.01 | mg/l |
| Barium | 3.11 | mg/l | 0.244 | mg/l |
| Boron | 11.6 | mg/l | 9.2 | mg/l |
| Calcium | 197 | mg/l | 40.6 | mg/l |
| Cobalt | 0.00509 | mg/l | 0.005 | mg/l |
| Copper | 0.0827 | mg/l | 0.006 | mg/l |
| Lithium | 3.02 | mg/l | 2.93 | mg/l |
| Magnesium | 22.8 | mg/l | 0.2 | mg/l |
| Manganese | 0.642 | mg/l | 0.005 | mg/l |
| Mercury | 0.000112 | mg/l | 0.00002 | mg/l |
| Molybdenum | 0.0333 | mg/l | 0.005 | mg/l |
| Potassium | 998 | mg/l | 266 | mg/l |
| Selenium | 0.133 | mg/l | 0.005 | mg/l |
| Sodium | 3590 | mg/l | 3400 | mg/l |
| Strontium | 23.4 | mg/l | 5.54 | mg/l |
| Zinc | 0.0828 | mg/l | 0.0003 | mg/l |
| Iron | 26.3 | mg/l | 4.01 | mg/l |
| BOD, 5 day | 859 | mg/l | 678 | mg/l |
| Bromide | 54 | mg/l | 51.4 | mg/l |
| Chemical Oxygen Demand | 1600 | mg/l | 90.7 | mg/l |
| (COD) | | | | |
| Chloride | 6880 | mg/l | 6800 | mg/l |
| Cyanide, total | 0.024 | mg/l | 0.023 | mg/l |
| Fluoride | 0.82 | mg/l | 0.042 | mg/l |
| Solids, Total Suspended | 138 | mg/l | 13 | mg/l |
| Specific Conductivity | 17300 | umhos/cm | 18200 | umhos/cm |
| Sulfate | 119 | mg/l | 110 | mg/l |
| Sulfide | 2.2 | mg/l | 0.7 | mg/I |
| Turbidity | 214 | ntu | 7.7 | ntu |
| Alkalinity, Total as CaC03 | 388 | mg/l | 325 | mg/I |
| Corrosivity, Total as | 0.12 | SI | 0.1 | SI |
| CaC03 | | | | |
| Solids, Total Dissolved | 12200 | mg/l | 11800 | mg/I |

| | | |
|---|---|---|
| pH | 6.77 | 7.27 |

As shown by the above data, both examples start with contaminated water that is not suitable for use as frac water and after treatment with system 100, provide water that is suitable for use as frac water. For example, Table 1 shows a reduction in the suspended solids from 108 to 28 mg/l, water hardness from 687 to 205, oil and grease from 1500 to 11, calcium from 236 to 82 mg/l, magnesium from 23 mg/l to a non-detectable amount, barium from 19 to 1 mg/l, iron from 169 to 0.18 mg/l, benzene from 3000 to 0 ug/l, o-xylene from 180 ug/l to a non-detectable amount, toluene from 2500 to 690 ug/l, napthalene from 460 ug/l to a non-detectable amount, and diesel range organics from 4800 to 38 ug/l after treatment with the water treatment system 100 as outlined in Example 1. For instance, Table 2 shows a reduction in the suspended solids from 138 to 13 mg/l, COD from 1600 to 90 mg/l, calcium from 197 to 40, magnesium from 22 to 0.20 mg/l, barium from 3.11 to 0.24 mg/l, iron from 26 to 4 mg/l, benzene from 2400 to 1200 ug/l, xylene from 2800 to 2250 ug/l, turbidity from 214 to 7 NTU, and corrosivity from 0.12 to 0.10 SI after treatment with the water treatment system 100 as outlined in Example 2. The amounts of the above materials as found in the contaminated water causes scaling problems, prevent gel formation, and create formation damage when utilized in frac water.

What is claimed is:

1. A system for treating contaminated water, the contaminated water containing some amount of polyacrylamides, emulsified hydrocarbons, and sequestered divalent cations, the system comprising:
at least one pre-treatment tank;
at least one chemical treatment tank fluidically connected to the pre-treatment tank, wherein the treatment tank comprises a chemical injection system connected to an interior of the at least one chemical treatment tank;
at least one clarifier fluidically connected to the at least one chemical treatment tank, the at least one clarifier comprising a mechanical contaminant removal system; and
a filter skid fluidically connected to the at least one clarifier, wherein the filter skid comprises a plurality of filter cartridges.

2. The system of claim 1, wherein the pretreatment tank comprises:
an inlet at a first predetermined height from a bottom of the pretreatment tank; and
an outlet at a second predetermined height from the bottom of the pretreatment tank, wherein the second predetermined height is less than the first predetermined height.

3. The system of claim 1, wherein the at least one pretreatment tank comprises six pretreatment tanks

4. The system of claim 1, wherein the at least one chemical treatment tank comprises a chemical injection system comprising:
a chemical container; and
a chemical introduction line fluidically coupling the chemical container and the interior of the at least one chemical treatment tank.

5. The system of claim 1, wherein the at least on chemical treatment tank comprises:
a chemical treatment tank housing;
a mixer;
an exhaust system for exhausting a gas from the interior of the chemical treatment tank housing; and
a solid waste line fluidically coupled to a lower portion of the chemical treatment tank housing.

6. The system of claim 1, wherein the at least one chemical treatment tank comprises four chemical treatment tanks.

7. The system of claim 1, wherein the mechanical contaminant removal system comprises:
a rake system comprising:
a rake comprising at least one paddle arm;
a shaft coupled to the rake; and
a rake drive mechanism comprising a motor for moving the shaft; and
a curtain system comprising at least one of:
a vertically movable curtain located within an interior of the clarifier; and
a stationary curtain located within the interior of the clarifier.

8. The system of claim 1, further comprising a solid waste removal system comprising:
a buffer tank fluidically connected to the clarifier;
a hydrocyclone fluidically connected to an outlet of the buffer tank; and
an outlet coupled to a lower portion of the hydrocyclone for removal of a solid waste.

9. The system of claim 1, further comprising a sulphide monitoring system coupled to at least one of the at least one clarifiers.

10. The system of claim 1, wherein the at least one clarifier comprises a plurality of clarifiers.
